(19) United States
(12) Patent Application Publication
(10) Pub. No.: US 2024/0035530 A1
(43) Pub. Date: Feb. 1, 2024

(54) BRAKE NODES

(71) Applicant: Divergent Technologies, Inc., Los Angeles, CA (US)

(72) Inventors: Marco PAGNI, Los Angeles, CA (US); Claudio Alberto Caprarella, Lon Angles, CA (US); Kevin Robert Czinger, Santa Monica, CA (US); William David Kreig, Huntington Beach, CA (US); Ewan John Cooper bALDRY, lOS aNGELES, CA (US)

(21) Appl. No.: 18/360,716

(22) Filed: Jul. 27, 2023

Related U.S. Application Data
(60) Provisional application No. 63/392,823, filed on Jul. 27, 2022.

(51) Int. Cl. F16D 65/095; F16D 66/02; F16D 66/00

(52) U.S. Cl. CPC F16D 65/095; F16D 66/021; F16D 2066/003; F16D 2066/001; F16D 2066/005

(57) ABSTRACT

Aspects are provided herein for vehicle structures. The vehicle structures can include a caliper portion configured to apply a braking force, the caliper portion including an inner housing, an outer housing, and a bridge portion, wherein the bridge portion connects the inner housing and the outer housing. In various embodiments, the outer housing can include an inner surface configured to face a rotor, in which the inner surface includes a sweep area configured to allow the rotor to tilt during installation and removal of the rotor. The vehicle structures can further include an upright portion configured to couple to a wheel of a vehicle, the upright portion being connected to the inner housing. Further, the vehicle structure can include a stiffening portion that connects the upright portion to at least the bridge portion or the outer housing. In various embodiments, the vehicle structures can be 3D-printed.

### CROSS-REFERENCE TO RELATED APPLICATION

This application claims the benefit of, and right to priority to, United States Provisional Patent Application No. 63/392,823 filed on Jul. 27, 2022, and entitled “Brake Nodes,” the contents of which are incorporated by reference as if fully set forth herein.

### BACKGROUND

### Field

The present disclosure relates generally to braking and suspension systems for land vehicles such as automobiles, and more specifically to integration of brake calipers with suspension components such as wheel uprights.

### Background

Cars are complex machines with many separate, dedicated systems. For example, cars have braking systems whose function is to apply braking force to wheels to stop the car. A braking system can include components such as rotors and braking pads, and can include an associated brake caliper that seats the brake pads and applies the brake pads to the rotor with such force that friction slows and stops the rotor and the wheel attached to the rotor. Cars also have suspension systems that bear the weight of the car and bear various dynamic loads experienced by the car during driving, cornering, stopping, etc. A suspension system can include, for example, wheel uprights (also referred to as wheel carriers, knuckles, or simply, uprights) that attach to the wheel and allow the wheel to rotate. Various other suspension components may be attached to the upright, such as control arms and other linkages, to allow the upright to turn the wheel and move with the up and down motion of the wheel when driving over bumps, for example.

Conventionally, the brake caliper and the upright are separate components. The brake caliper (specifically, the inner housing of the caliper) is bolted onto the upright with the rotor positioned in between the brake pads. When it is necessary to service the brakes, the brake caliper is unbolted from the upright and lifted off to allow the rotor and brake pads to be removed.

### SUMMARY

In this disclosure, it is recognized that the brake caliper and upright can be formed as an integral structure. In various embodiments, various advantages may be realized as described in more detail below for various embodiments. For example, benefits may include weight savings, rigidity, fewer parts, less assembly, built-in features, improved vehicle dynamics, etc. In various embodiments including an integrated vehicle structure, fewer parts may allow easier or faster brake maintenance or service.

However, integrating the brake caliper and upright poses challenges. For example, because the brake caliper cannot be unbolted or removed from the upright, it may be difficult or impossible to remove the rotor during brake servicing without removing the entire integrated brake caliper and upright. In this case, servicing the brakes may be very difficult and time-consuming. Various embodiments of this disclosure may mitigate or eliminate this problem. For example, an integrated caliper and upright may include a sweep area on an inner surface of the outer housing that allows the rotor to tilt such that the portion of the rotor that connects to the wheel may be disconnected and the rotor removed.

In various embodiments disclosed herein are vehicle structures. In one aspect, the vehicle structure includes a caliper portion configured to apply a braking force. For example, the caliper portion can include an inner housing, an outer housing, and a bridge portion, in which the bridge portion connects the inner housing and the outer housing. In one or more embodiments, the vehicle structure includes an upright portion configured to couple to a wheel of a vehicle. For example, the upright portion can be connected to the inner housing of the caliper portion.

Additionally, in one or more embodiments, the vehicle structure can include a stiffening portion that connects the upright portion to at least the bridge portion or the outer housing. For example, the stiffening portion can include an outer stiffening structure configured to connect the upright portion to the outer housing. In another example, the stiffening portion includes a bridge stiffening structure configured to connect the upright portion to the bridge portion. These exemplary stiffening portions can further include a cross stiffening structure that connects the upright portion to the outer stiffening structure. In one or more embodiments, the stiffening portion can include a cross stiffening structure configured to connect an outer stiffening structure to a bridge stiffening structure. In one or more embodiments, the stiffening portion can be configured to reduce noise, vibration, and harshness (NVH).

In one or more embodiments, the caliper portion, the upright portion, and the stiffening portion can be an integral structure. In one or more embodiments, the caliper portion, the upright portion, and the stiffening portion can be 3D-printed structures. Further, in one or more embodiments, the caliper portion includes a printed-in fluid channel configured to provide brake fluid to the inner and outer housings. In other embodiments, the upright portion or the stiffening portion includes a portion of the printed-in fluid channel. In one or more embodiments the caliper portion, the upright portion, or the stiffening portion can be at least partially hollow.

In one or more embodiments, the vehicle structure includes a cooling element configured to increase cooling of at least a portion of the vehicle structure. For example, the cooling element includes at least 3D-printed fins, a channel for airflow, a channel for airflow from a wheel well, an air scoop, a diffuser, or a cross-bridge cooling duct.

In one or more embodiments, the caliper portion, the upright portion, or the stiffening portion includes a printed-in channel for installing at least a wiring or a sensor. For example, the printed-in channel can be configured for at least a pad wear warning sensor, a temperature sensor, or a smart brake pad sensor.

In another aspect, the vehicle structure includes a caliper portion configured to apply a braking force. The caliper portion can include an inner housing, an outer housing, and a bridge portion, in which the bridge portion connects the inner housing and the outer housing. Moreover, the outer housing can include an inner surface configured to face a rotor, in which the inner surface includes a sweep area configured to allow the rotor to tilt during installation and removal of the rotor. The sweep area can include a curved surface. In one or more embodiments, the vehicle structure includes an upright portion configured to couple to a wheel of a vehicle, the upright portion being connected to the inner housing.

In one or more embodiments, the vehicle structure further includes a seat configured to seat a pad stopper. For example, the seat can be arranged at a forward side of the caliper portion. The pad stopper can be configured to transfer a force from a portion of a brake pad to the vehicle structure, in which the portion of the brake pad is an area of the brake pad that, because of the sweep area, would not be in contact with the vehicle structure during braking. For example, the seat can be configured to seat a plate-like pad stopper. Moreover, the seat can include a slot. In one or more embodiments, the seat can be configured to seat a pad stopper that includes stopper portions for both an inner brake pad and an outer brake pad. In one or more embodiments, the seat can be configured to seat a pad stopper that includes a stopper portion for only an outer brake pad. In one or more embodiments, the vehicle structure can include a second seat configured to seat a second pad stopper, in which the second seat can be arranged at a rear side of the caliper portion.

In one or more embodiments, the caliper portion can be a 3D-printed structure, and the caliper portion includes a printed-in fluid channel configured to provide brake fluid to the inner and outer housings. For example, the upright portion or a stiffening portion that connects the upright portion to at least the bridge portion or the outer housing can be a 3D-printed structure and can include a portion of the printed-in fluid channel.

In one or more embodiments, the vehicle structure further includes a cooling element configured to increase cooling of at least a portion of the vehicle structure. For example, the cooling element can include at least 3D-printed fins, a channel for airflow, a channel for airflow from a wheel well, an air scoop, a diffuser, or a cross-bridge cooling duct.

In one or more embodiments, at least the caliper portion, the upright portion, or a stiffening portion that connects the upright portion to at least the bridge portion or the outer housing can include a printed-in channel for installing at least a wiring or a sensor. For example, the printed-in channel can be configured for at least a pad wear warning sensor, a temperature sensor, or a smart brake pad sensor.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1 illustrates a side perspective view of an example vehicle structure according to an embodiment.

FIG. 2 illustrates a top view of the example vehicle structure of FIG. 1.

FIG. 3 illustrates a bottom view of the example vehicle structure of FIG. 1.

FIG. 4 illustrates a rear view of the example vehicle structure of FIG. 1.

FIG. 5 illustrates a second rear view of the example vehicle structure of FIG. 1 with the vehicle structure rotated toward the front.

FIG. 6 illustrates a front view of the example vehicle structure of FIG. 1.

FIG. 7 illustrates a view of the example vehicle structure of FIG. 1 rotated between the top and front views.

FIG. 8 illustrates a front cross-sectional view of an example vehicle structure according to another embodiment.

FIG. 9 illustrates the front cross-sectional view of the example vehicle structure of FIG. 8 with a rotor installed.

FIG. 10 illustrates the front cross-sectional view of the example vehicle structure of FIG. 8 with a rotor tilted to be uninstalled.

FIG. 11 illustrates a top view of an example vehicle structure according to another embodiment with a pad stopper seat configured to receive a pad stopper.

FIG. 12 illustrates the example vehicle structure of FIG. 11 with a pad stopper installed in the pad stopper seat.

FIG. 13 illustrates an inset view of an example vehicle structure with a pad stopper and brake pads installed.

FIG. 14 illustrates a front cross-sectional view of an example vehicle structure according to another embodiment.

FIG. 15 illustrates a top perspective view of an example vehicle structure according to another embodiment with a pad stopper seat configured to receive a pad stopper.

FIG. 16 illustrates a top view of the example vehicle structure of FIG. 15.

FIG. 17 illustrates a top view of the example vehicle structure of FIG. 15 with a pad stopper installed.

FIG. 18 illustrates a cross-sectional top view of the example vehicle structure of FIG. 15 with a pad stopper installed.

FIG. 19 illustrates an inset cross-sectional top view of the example vehicle structure of FIG. 15 with a pad stopper installed.

FIG. 20 illustrates a side perspective view of the example vehicle structure of FIG. 15 with a pad stopper installed.

FIG. 21 illustrates a side perspective view of an example vehicle structure according to another embodiment with a printed-in internal fluid channel.

FIG. 22 illustrates a side perspective view of an example vehicle structure of FIG. 21.

FIG. 23 illustrates an inset cross-sectional side perspective view of an example vehicle structure according to another embodiment.

FIG. 24 illustrates an inset cross-sectional side perspective view of the example vehicle structure of FIG. 23 with a diffuser and a cross-bridge cooling duct.

FIG. 25 illustrates an inset side perspective view of an example vehicle structure according to another embodiment with printed-in fins.

FIG. 26 illustrates an inset side perspective view of an example vehicle structure according to another embodiment with a printed-in channel.

FIG. 27 illustrates a bottom perspective view of an example vehicle structure according to another embodiment.

FIG. 28 illustrates a top side perspective view of an example vehicle structure according to another embodiment.

FIG. 29 illustrates a bottom side perspective view of an example vehicle structure according to another embodiment.

FIG. 30 illustrates a side perspective view of an example vehicle structure according to another embodiment.

FIG. 31 illustrates a top perspective view of an example vehicle structure according to another embodiment.

FIG. 32 illustrates a side view of an example vehicle structure according to another embodiment.

FIG. 33 illustrates a side perspective view of an example vehicle structure according to another embodiment.

### DETAILED DESCRIPTION

Several solutions have been developed to maximize the structural rigidity of brake calipers, however all these known solutions maintain the typical architecture of traditional disc brake calipers, where the outer housing is connected to an inner housing, and the inner housing is connected to the wheel upright. Such brake caliper architectures typically rely on two or more connecting bridges across inner and outer housings that handle all the clamping force generated across the brake rotor and the tangential force exercised by the outer brake pad for effect of friction. The rigidity of the structure, or, more in general, its weight-to-stiffness ratio is therefore affected by the design of such connecting bridges, which is in turn constrained by the available space between brake rotor and wheel rim. At the same time, when it comes to addressing potential system dynamic instabilities and NVH phenomena, like, for instance, brake squeals, those said known solutions do not allow much degree of freedom in adjusting the design of the brake caliper to fine tune its vibration modes, especially the so-called torsional and shear modes, as the above mentioned connecting bridges do not play a significant contribution to those vibration modes.

To overcome the above mentioned limitations associated with the traditional brake caliper design, the need is felt to come up with a brake caliper assembly which has both the inner and outer housing independently interconnected by the main wheel upright structure by mean of supporting structural elements, thus allowing an improved weight-to-stiffness ratio of the product and additional capabilities to tune its vibration modes to address brake NVH issues. A braking node is a vehicle structure including a wheel upright portion (also referred to as an carrier or a knuckle) suitable to hold and connect the wheel hub-bearing unit to the cinematic points of the suspension links (e.g., strut links), and a disc brake caliper portion including inside and outside housings configured to face respective sides of a brake rotor and configured to contain a set of pistons, seals and dust boots to convert an hydraulic pressure into a clamping force on the rotor. The upright portion and the caliper portion are formed as an integral structure, e.g., by 3D printing as one piece, and include stiffening structures between the upright and a central (aka bridge) portion of the caliper and between the upright and the outer housing. A braking node may include an internal hydraulic channel to distribute pressure within the structure, one or more bleeder screws with dust cap to allow filling and bleeding the hydraulic circuit. A braking node may include a removable pad stopper to transmit the tangential forces from one or more brake pads to the rest of the structure, the forces being generated by the braking action of applying the pads to the spinning rotor. A braking node may include a connecting tie-rod to contain the deformation of the caliper housing. A braking node may be configured to seat two brake pads, using removable retaining pins and clip to hold the brake pads in place and a spring to avoid excessive rattling and creaking of the assembly. On certain applications, the braking node can also be equipped with electric park brake devises (electric Drum-In-Hat or electric Parking Brake Calipers).

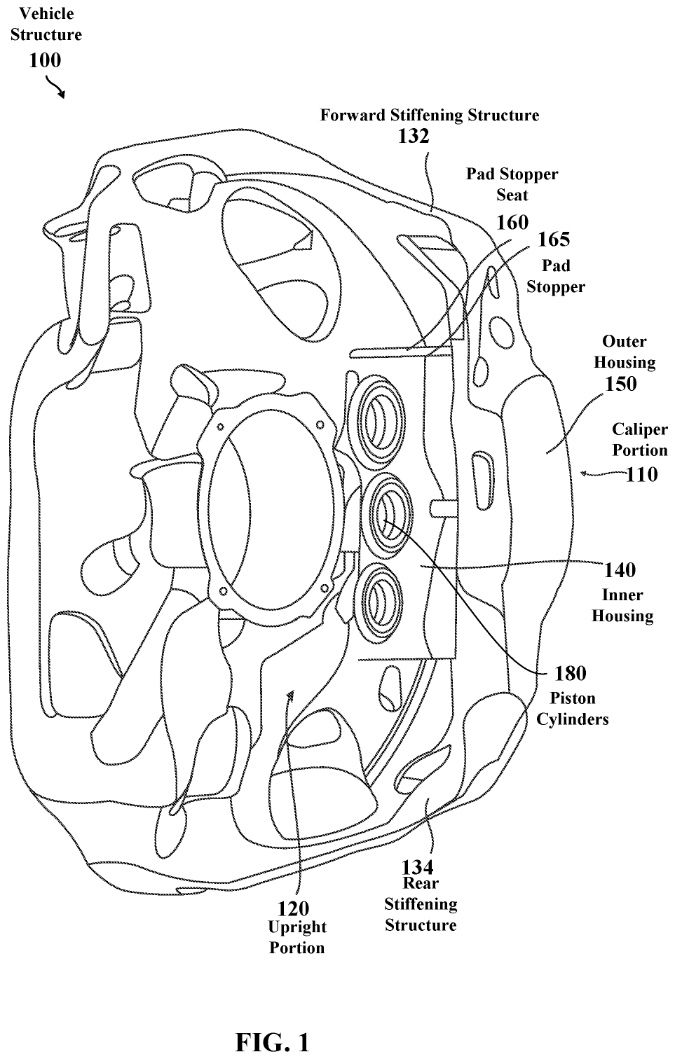

FIG. 1 illustrates an example of a vehicle structure 100 according to one or more embodiments herein. The vehicle structure 100 includes a caliper portion 110, an upright portion 120, and a stiffening structure including a forward stiffening structure 132 and a rear stiffening structure 134. The caliper portion 110 includes inner and outer housings 140, 150, and a pad stopper seat 160. The pad stopper seat 160 is configured to receive a pad stopper 165 in the seat. The inner and outer housings 140, 150 include piston cylinders 180 and are configured to house pistons that are hydraulically activated to exert a braking force on a rotor (not shown). The stiffening structure includes forward stiffening structure 132 arranged at a forward side of the caliper portion 110 (i.e., the side at which forward-driving rotor motion is moving away from the caliper) and rear stiffening structure 134 arranged at a rear side of the caliper portion 110 (i.e., the side at which forward-driving rotor motion is moving toward the caliper). From the perspective shown in FIG. 1, a rotor motion would be seen as counterclockwise, i.e., the portion of the rotor passing through the caliper would be moving upward in the figure.

In various embodiments, the stiffening structure can provide stiffness for the connection of the caliper portion 110 and the upright portion 120. In various embodiments, the stiffening structure can reduce a noise, vibration, and harshness (NVH) of the vehicle structure. In various embodiments, such as the vehicle structure 100 shown in the figures, the caliper portion 110, upright portion 120, and the stiffening structure can be an integral structure, i.e., formed as a single part. For example, in various embodiments, the vehicle structure 100 can be 3D printed. 3D printing the vehicle structure 100 can allow several advantages because of the complex shapes that can be printed. For example, the entire structure may be topology optimized to provide the required performance characteristics (such as stiffness, NVH) at a reduced weight compared to traditional caliper and upright assemblies. The reduced weight of the vehicle structure 100 equates to reduced unsprung mass, which can increase the performance of a vehicle such as vehicle dynamics. In addition, forming the vehicle structure 100 as an integrated structure can reduce the part count versus traditional caliper and upright assemblies, which can in turn reduce cost associated with assembly time (i.e., no assembly needed for the integrated vehicle structure) and sourcing of different parts, which may mitigate supply chain issues. In various embodiments, having an integral design may allow built-in cooling elements as described in more detail herein.

Although the various embodiments described herein are directed to an integral vehicle structure, it is noted that the caliper portion 110, upright portion 120, and/or the stiffening structure may be formed as separate parts that are assembled together. For example, the caliper portion, upright portion, and stiffening structure may be formed as separate parts and glued or bolted together. In the present embodiment, portions of the vehicle structure 100 may be hollow, which may provide better stiffness-to-weight than completely solid structures.

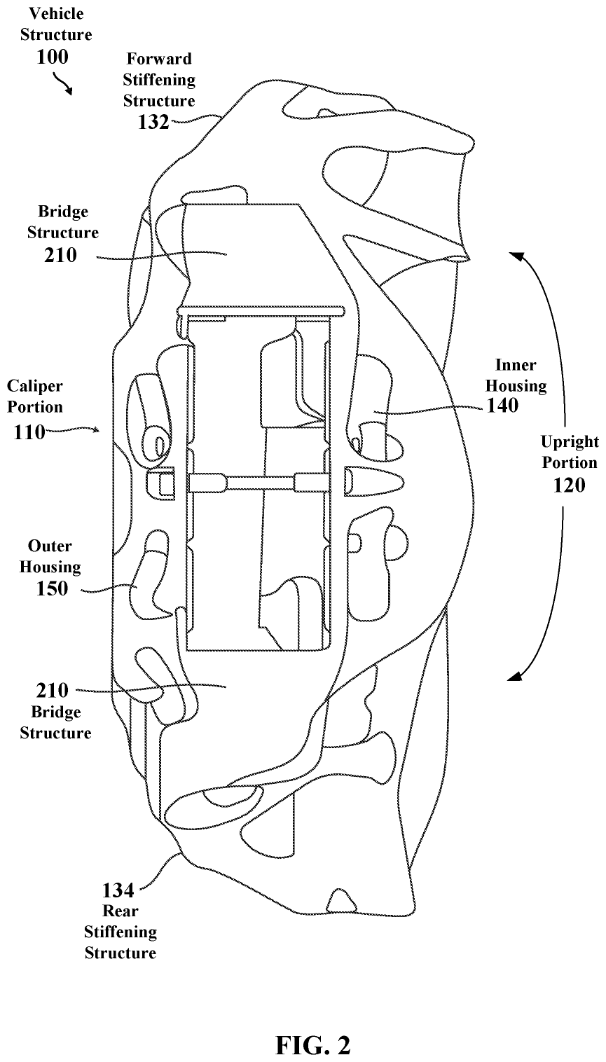

FIG. 2 illustrates the example vehicle structure 100 from a caliper top view, i.e., looking down on the caliper 110. As can be seen in the FIG. 2, the caliper portion 110 also includes a bridge structure 210 (also referred to as a central structure). In this example, the bridge structure 210 includes two portions, i.e., one upper and one lower as seen in the figure. In various embodiments, a bridge structure 210 may include one or more distinct portions.

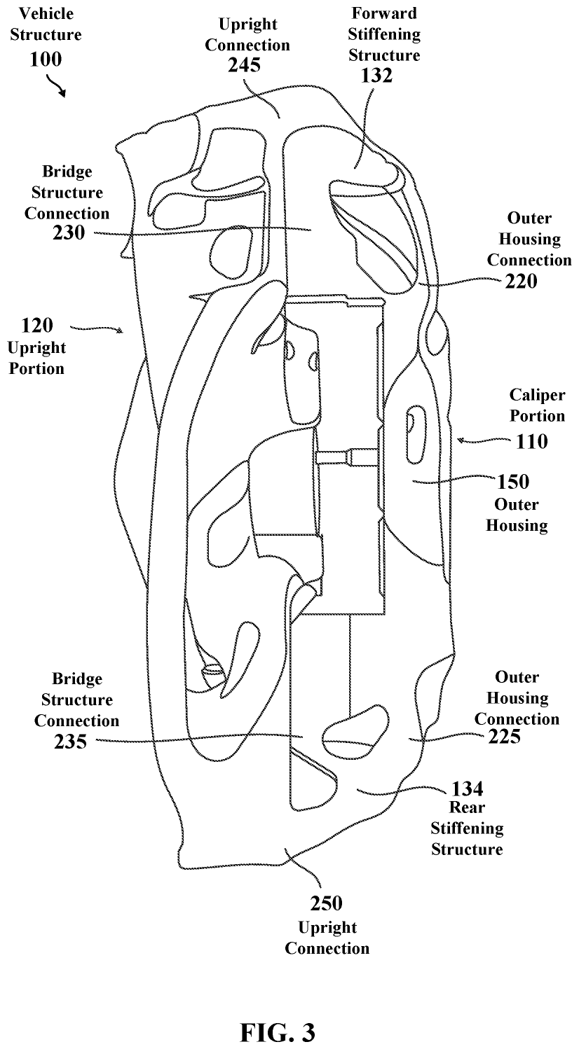

FIG. 3 illustrates the example vehicle structure 100 from a caliper bottom view, i.e., looking up at the caliper portion 110. As shown in the figure, the stiffening structures 132, 134 can connect to the outer housing 150 (outer housing connections 220, 225) and can connect to the bridge structure 210 (bridge structure connections 230, 235). It is noted the bridge structure connection of the rear stiffening structure 134 is partially obstructed by the upright portion in the figure. The stiffening structures 132, 134 can connect to the upright portion 120 at upright connections 245, 250.

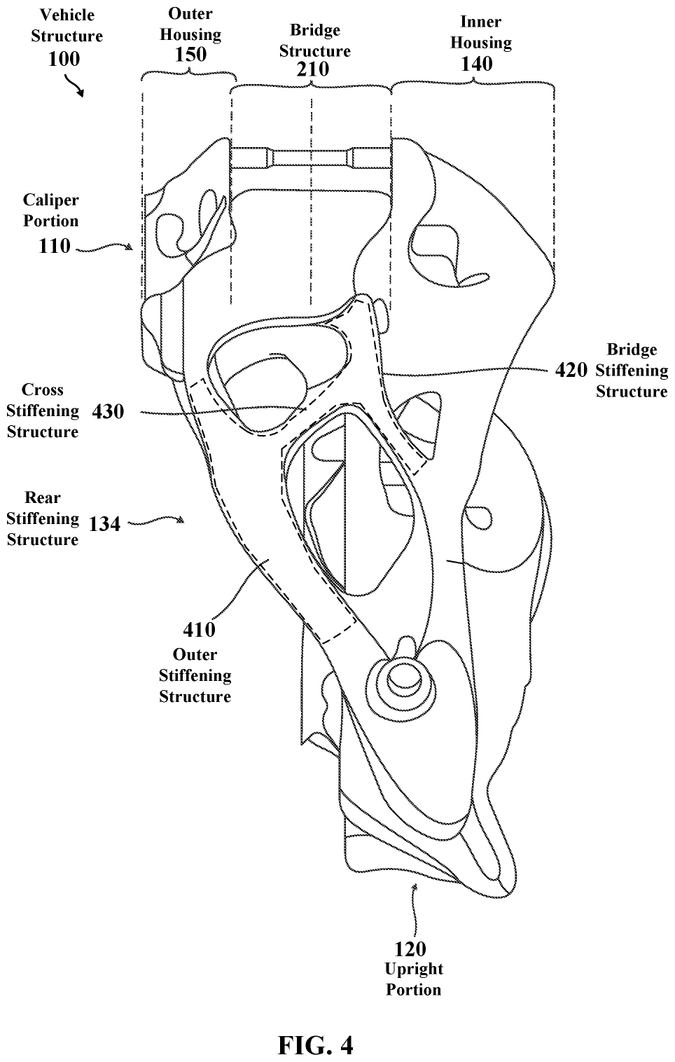

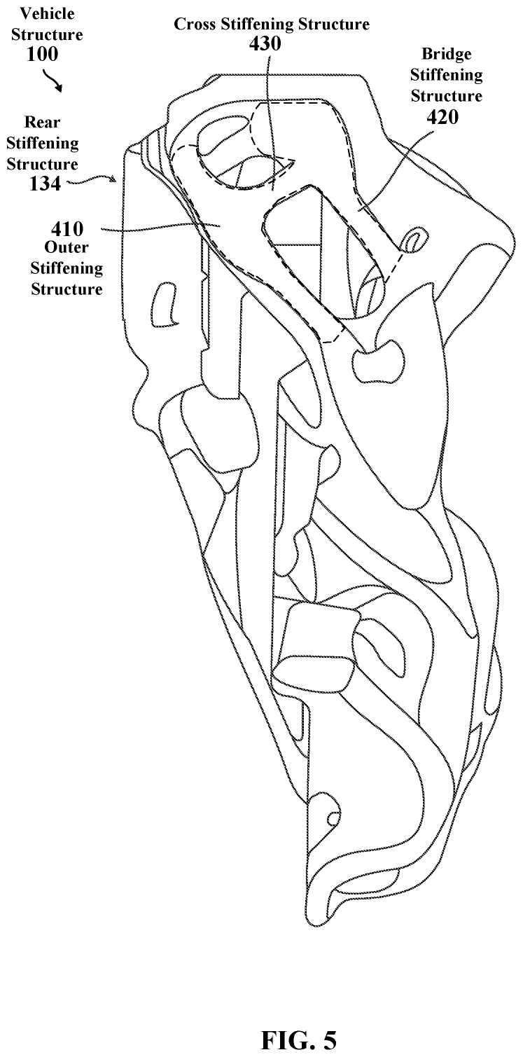

FIGS. 4 and 5 illustrate the example vehicle structure 100 showing details of the rear stiffening structure 134. The rear stiffening structure 134 (shown with dashed lines) can include an outer (housing) stiffening structure 410 that connects the upright portion 120 to the outer housing 150, a bridge stiffening structure 420 that connects the upright portion to the bridge structure 210, and a cross stiffening structure 430 that connects the outer stiffening structure to the bridge stiffening structure. The cross stiffening structure 430 may provide additional stiffness and/or NVH improvement, for example. Although the cross stiffening structure 430 is shown connecting the outer stiffening structure 410 and the bridge stiffening structure 420, it is noted that in various embodiments, cross stiffening structures may connect the upright portion 120 to the outer stiffening structure, connect the upright portion to the bridge stiffening structure, and/or connect the outer stiffening structure to the bridge stiffening structure. Various combinations of cross stiffening structures 430 are within the scope of the disclosure. It is noted various embodiments may include an outer stiffening structure 410, but not a bridge stiffening structure 420, or include only a bridge stiffening structure but not an outer stiffening structure. These various combinations of stiffening structures may be applied in similar combinations or different combinations on the forward and rear stiffening structures 132, 134. Various embodiments may include only a forward stiffening structure, but not a rear stiffening structure, or may include only a rear stiffening structure but not a forward stiffening structure.

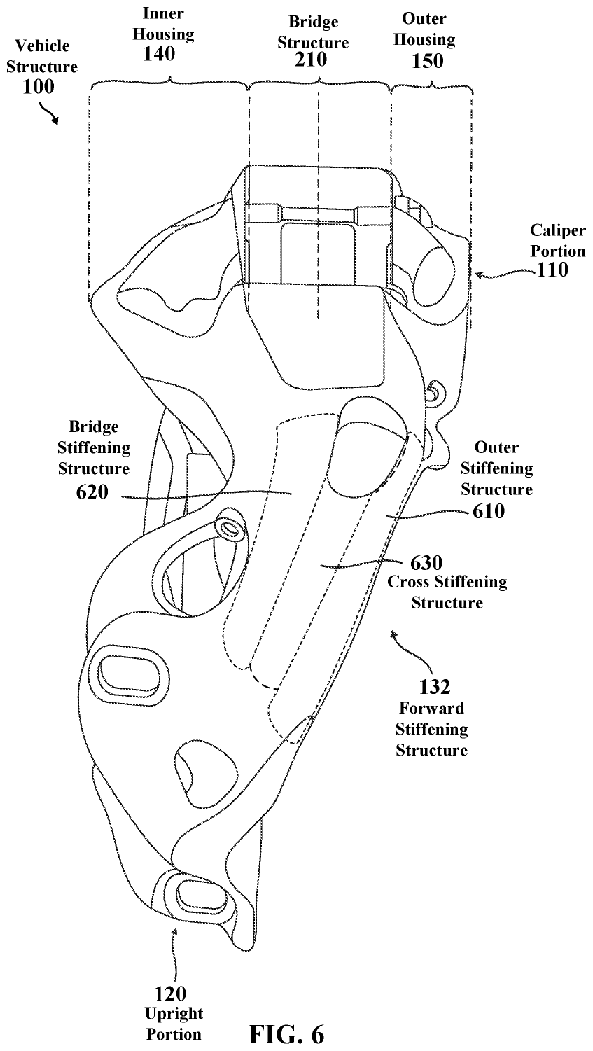

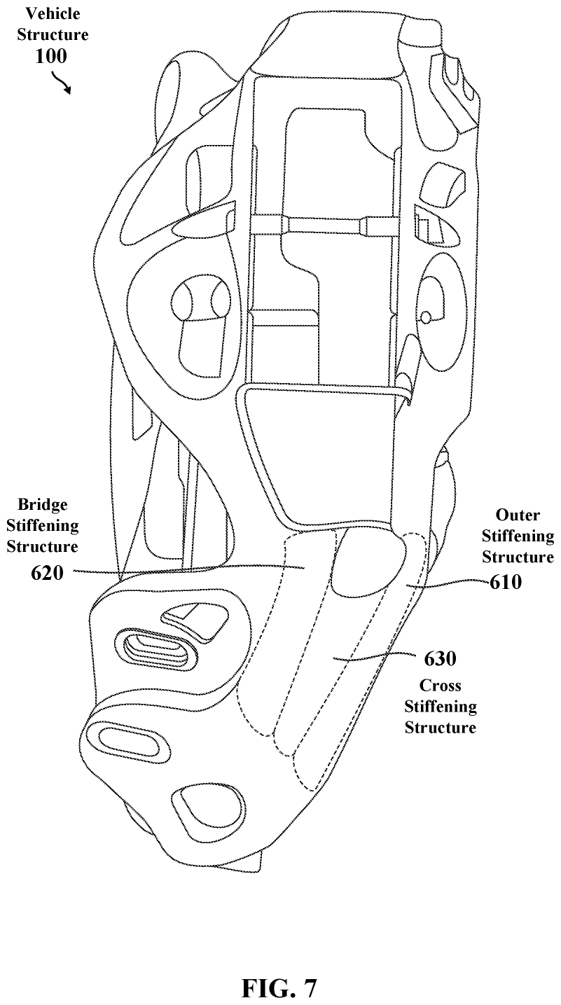

FIGS. 6 and 7 illustrate the example vehicle structure 100 showing details of the forward stiffening structure 132. The forward stiffening structure 132 can include an outer (housing) stiffening structure 610, a bridge stiffening structure 620, and a cross stiffening structure 630. As shown in FIG. 6, the cross stiffening structure 630 can begin at the upright portion 120 and run continuously between the outer and bridge stiffening structures 610, 620. In this example, the cross stiffening structure 430 does not connect directly to the caliper portion 110. In various embodiments, the cross stiffening structure 630 may connect to the caliper portion 110 so as to run continually from the upright portion 120 to the caliper portion, may connect to the caliper portion but not to the upright portion, or other various combinations.

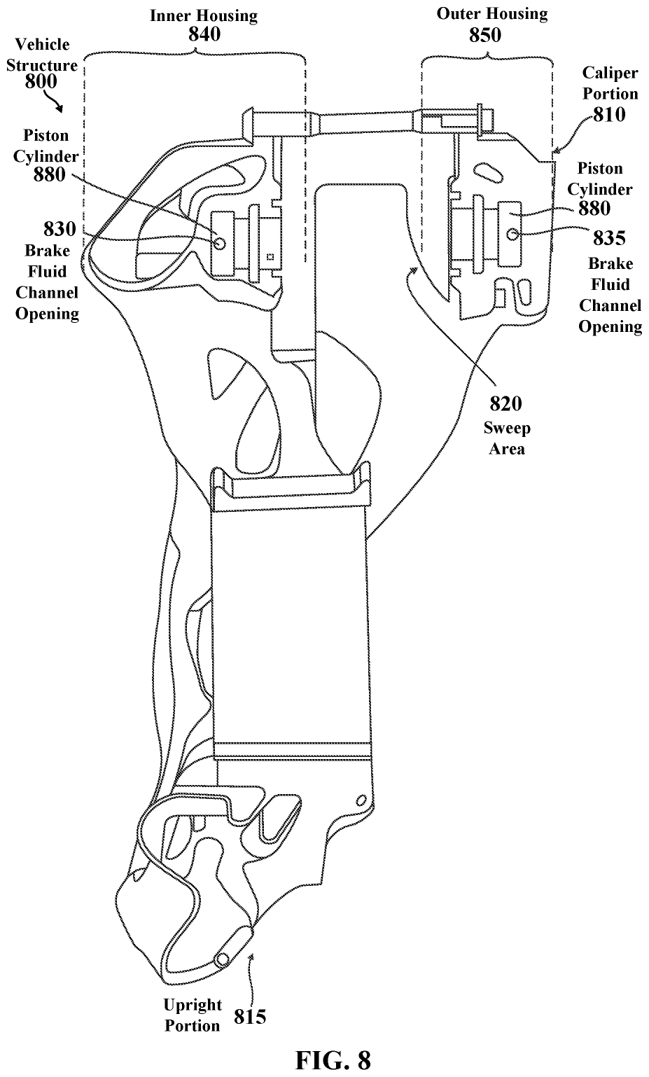

FIG. 8 illustrates a cross-section view of an example vehicle structure 800 according to one or more embodiments herein. The vehicle structure 800 includes a caliper portion 810 and an upright portion 815. The caliper portion 810 includes inner and outer housings 840, 850, and a pad stopper seat 160. The inner and outer housings 840, 850 include piston cylinders 880 and are configured to house pistons that are hydraulically activated to exert a braking force on a rotor. FIG. 8 also shows that the outer housing 850 includes an inner surface configured to face the rotor when the rotor is installed in the vehicle structure 800, and the inner surface can include a sweep area 820 that can allow the rotor to tilt during installation and removal of the rotor. The sweep area 820 can be a curved surface, for example. FIG. 8 further shows a cross section of the piston cylinders 880, in which can be seen brake fluid channel openings 830, 835 of a fluid channel that may be printed-in to the vehicle structure 800, as described in more detail herein.

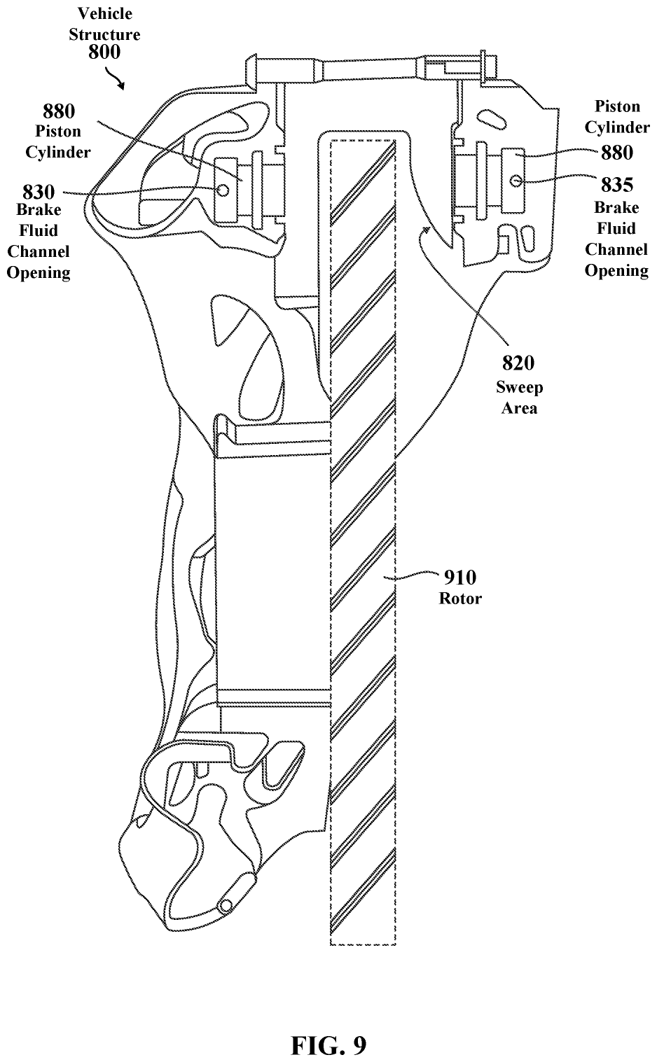

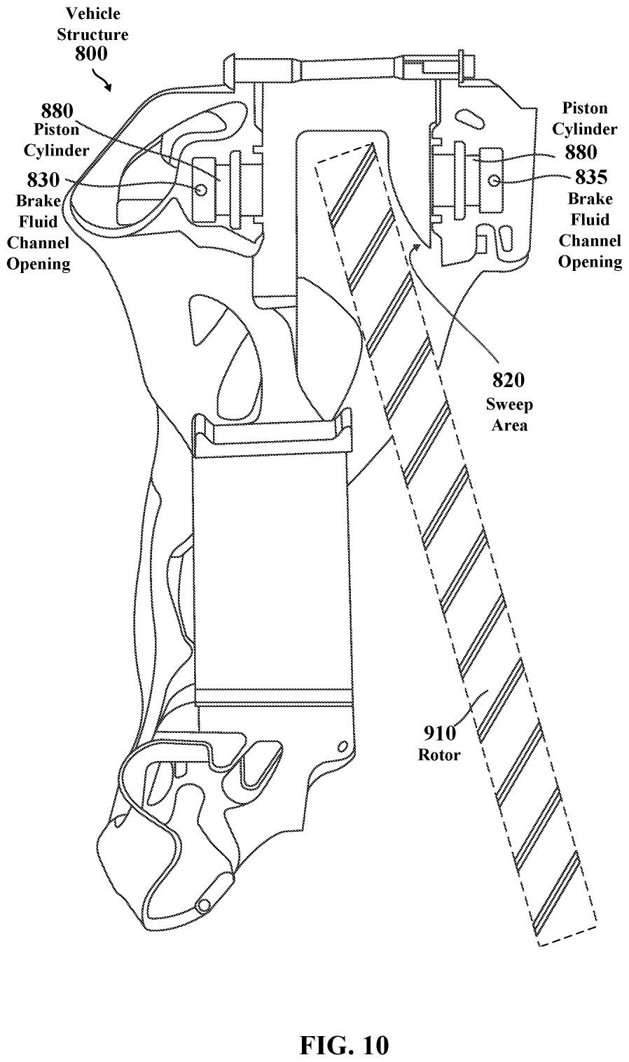

FIGS. 9 and 10 illustrate further cross-sectional views of the example vehicle structure 800 illustrated by FIG. 8. These figures show installation and removal of a rotor 910 from the vehicle structure 800. Specifically, FIGS. 9-10 show how the sweep area 820 can allow a rotor to tilt.

FIG. 9 illustrates the example vehicle structure 800 with a rotor 910 installed. It can be seen that the rotor 910 fits snuggly within the caliper portion, which can allow efficient operation of the braking system without excessive displacement needed (e.g., brake pedal displacement) or excessive moments applied to the pistons or pads.

FIG. 10 illustrates the example vehicle structure 800 with the rotor 910 tilted to be removed, i.e., uninstalled (or installed if the steps are reversed). As shown, the sweep area 820 can allow room for the rotor 910 to be tilted during installation or removal. In some embodiments, in which the caliper portion 810 and upright portion 815 are formed as an integral part, the sweep area 820 may be necessary to allow the rotor 910 to be removed (because the caliper portion cannot be disassembled from the upright portion, for example). In some embodiments, the sweep area may simply make removal or installation of the rotor 910 easier.

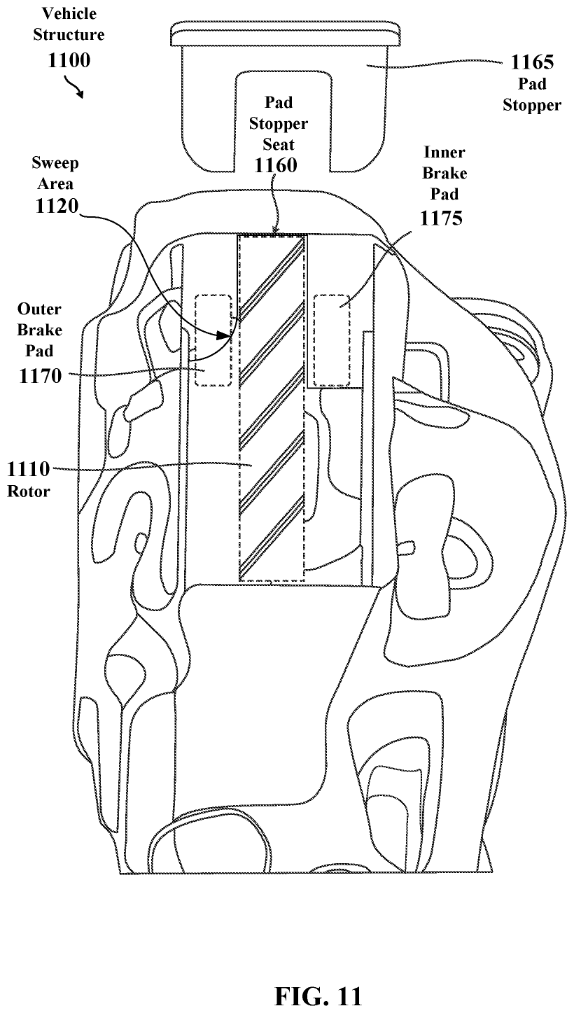

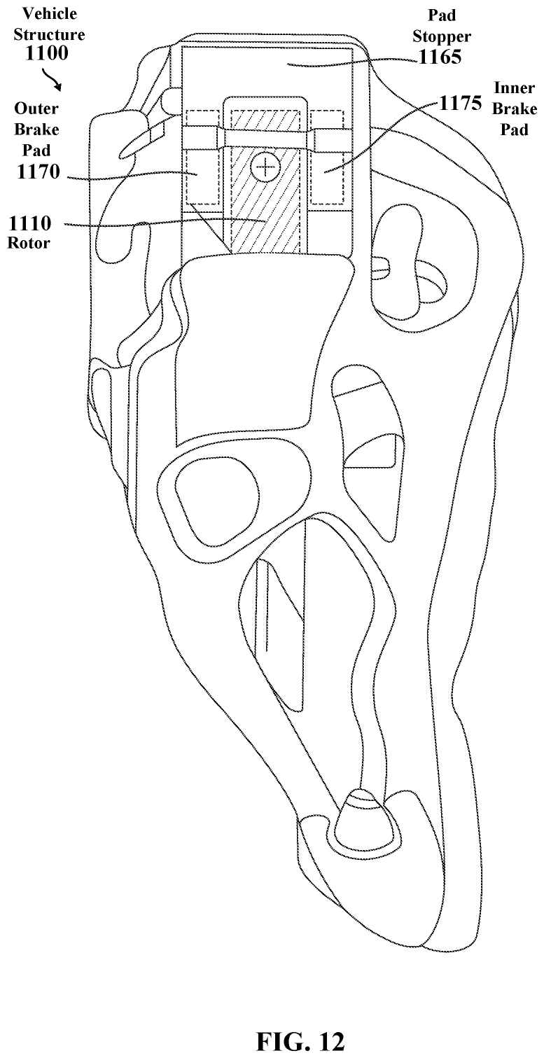

FIGS. 11 and 12 illustrate an example vehicle structure 1100 including a pad stopper seat 1160 that is configured to seat a pad stopper 1165 (shown uninstalled and floating in space in the figure). It is noted that typical caliper designs allow the forward edges of the brake pad 1170, 1175 to contact a surface of the caliper during braking. This can allow the side-to-side force of the brake pad as it sits in the caliper portion to transfer to the surface of the caliper portion, which is rigid and can accept the force without deformation. This blocking of the brake pad can be important because heavy braking can create tremendous forces on the brake pad in the side-to-side direction. The figure shows the direction of the rotor 1110 rotation is into the page at the location of the brake pads.

In one or more embodiments of the present disclosure, the addition of a sweep area 1120 may result in an area of the outer brake pad not being blocked by a caliper portion surface. FIG. 11 shows the arrangement of a forward edge of an outer brake pad 1170 (for clarity, the brake pad is not shown). Such an area not blocked is shown in the figure. Under heavy braking, the area not blocked may cause the outer brake pad to rotate in its seat, which is undesirable and potentially dangerous. The caliper portion can include a pad stopper seat (e.g., pad stopper seat 1160) that can seat a pad stopper (e.g., pad stopper 1165).

In FIG. 12, the pad stopper 1165 is illustrated as installed in the pad stopper seat 1160. As shown, the pad stopper 1165 can allow contact with the forward edge of the outer brake pad 1170 that would have not been in contact with a caliper portion surface due to the sweep area 1120. The pad stopper 1165 can allow the side-to-side force of the brake pad as it sits in the caliper portion to transfer to the surface of the pad stopper, which can be rigidly seated in the pad stopper seat 1160 and can transfer the force to the caliper portion. In this way, for example, the pad stopper 1165 can prevent a rotation of the brake pad in its seat under heavy braking.

In one or more embodiments, the pad stopper seat 1160 is configured to seat a pad stopper 1165 that includes stopper portions for both the outer brake pad 1170 and the inner brake pad 1175. In various embodiments, the pad stopper seat 1160 may be configured to seat a pad stopper 1165 that includes a stopper portion for only the outer brake pad 1170 but not the inner brake pad 1175. As seen in FIG. 12, for example, the inner surface of the inner housing may not need a sweep area 1120, and the forward edge of the inner brake pad may contact a caliper portion surface during braking.

In one or more embodiments, a single pad stopper seat is included at the forward side of the caliper portion (i.e., the side at which the forward-rotating rotor is moving away from the caliper portion center). In one or more embodiments, a second pad stopper seat may be included at the rear side of the caliper portion (i.e., the side at which the forward-rotating rotor is moving toward the caliper portion center). A pad stopper at the rear side can be effective when braking during backing up, i.e., when the car is moving backwards.

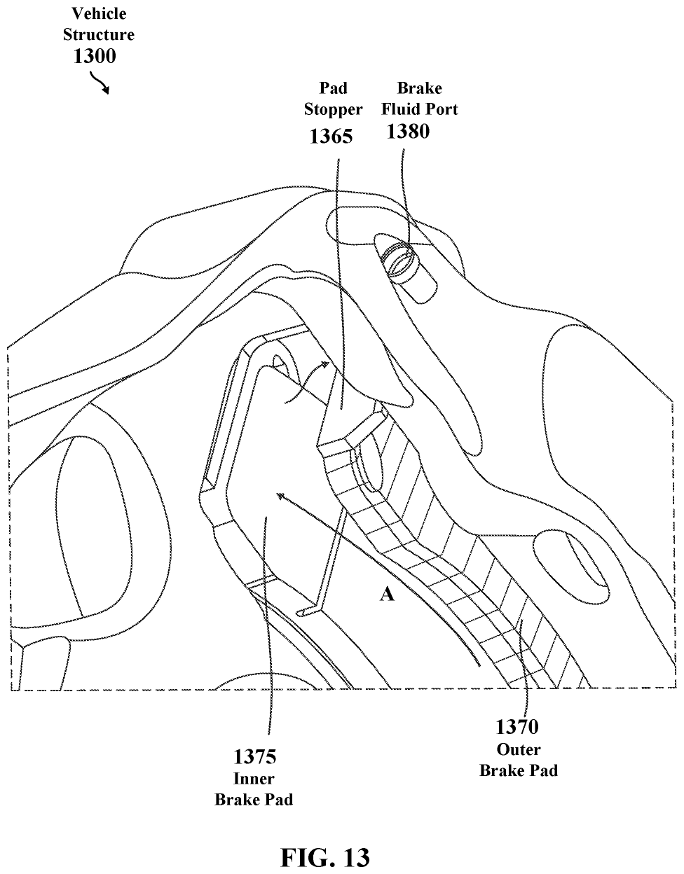

FIG. 13 illustrates an example vehicle structure 1300 showing a pad stopper 1365 installed in a pad stopper seat and the outer and inner brake pads 1370, 1375 installed. This figure illustrates the arrangement of the brake pad and the pad stopper, and how the pad stopper allows contact with the forward edge of the outer brake pad 1370 during braking. The direction of rotation by the rotor during forward driving is shown by the arrow labeled “A.” The figure also shows the brake fluid port 1380, which may access the printed-in fluid channel for brake fluid, described in more detail herein.

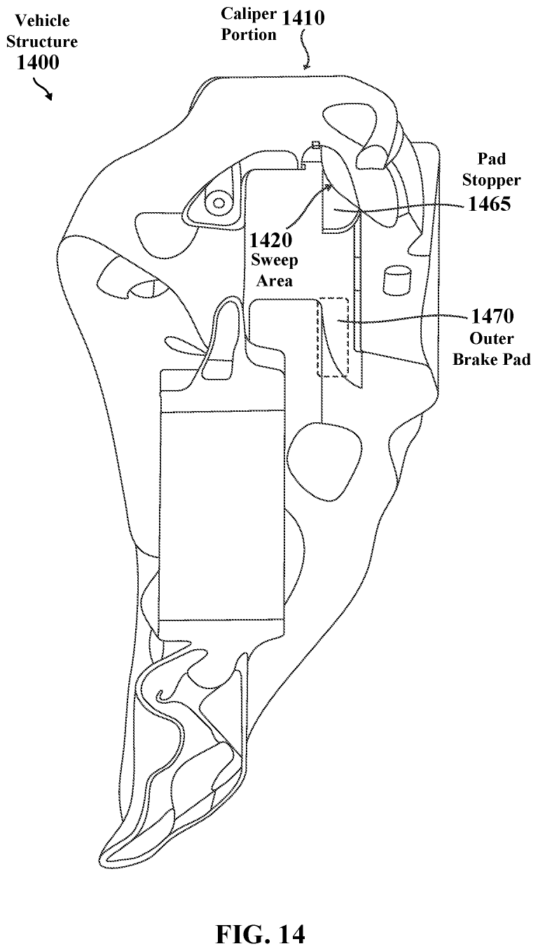

FIG. 14 illustrates a cross-sectional view of an example vehicle structure 1400 showing a sweep area 1420 included on the inner surface of an outer housing 1450 at the rear side of a caliper portion 1410. As disclosed herein, the rear edge of the outer brake pad 1470 is shown, illustrating that a portion of the rear edge may not contact a caliper portion surface. As disclosed herein, a pad stopper seat and pad stopper 1465 may be included at the rear side of the caliper portion to address braking in the reverse direction. In various embodiments, the speed of a vehicle in reverse is much less than the forward speed. In this case, a pad stopper may not be needed for the rear side of the caliper portion.

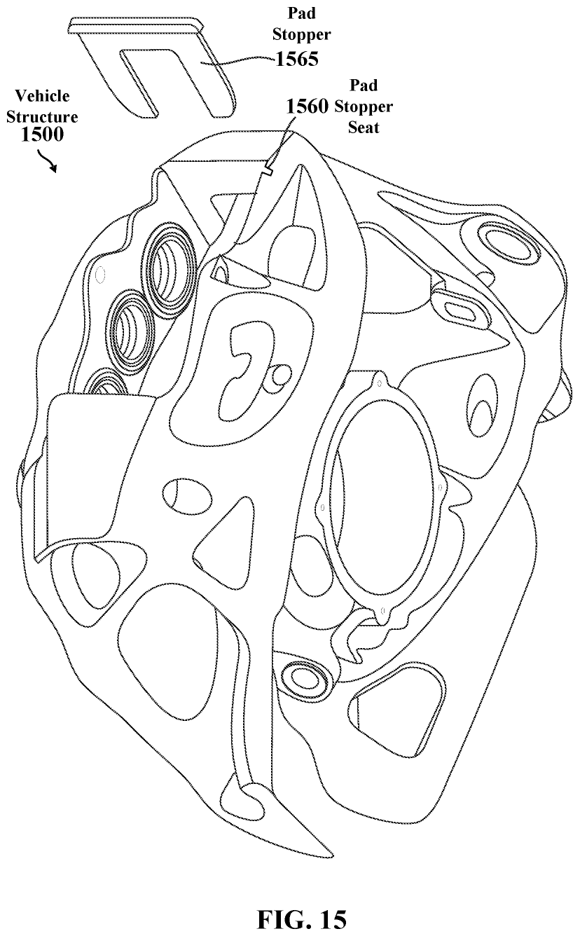

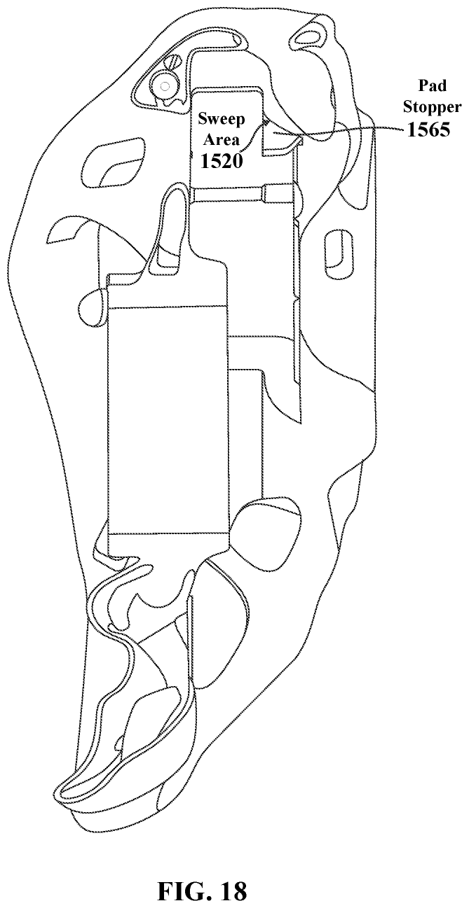

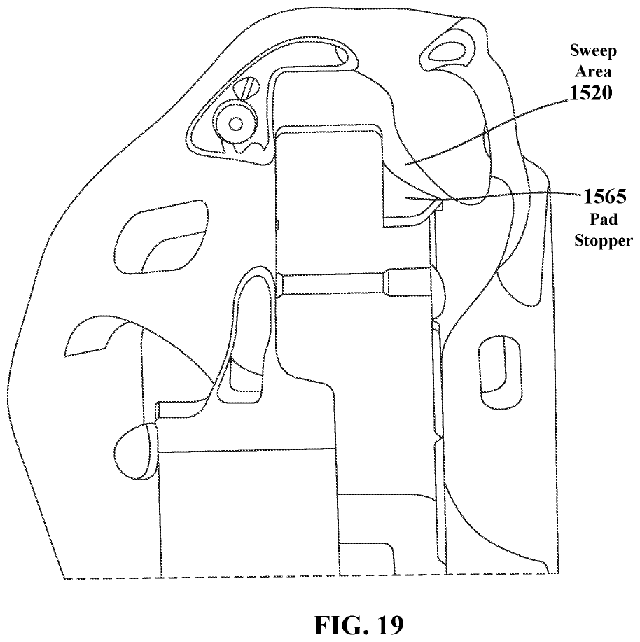

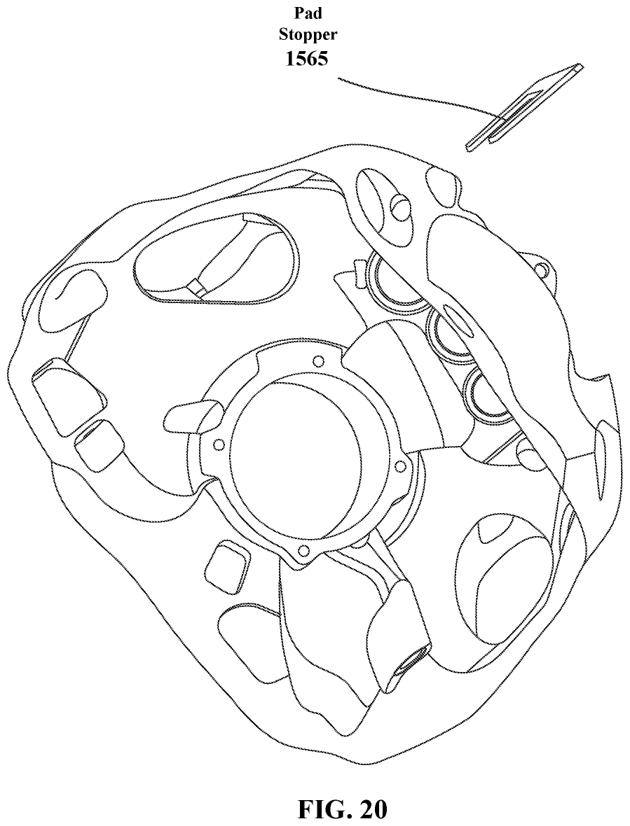

FIGS. 15-20 illustrates various viewpoints and cross-sections of an example vehicle structure 1500 with a pad stopper 1565.

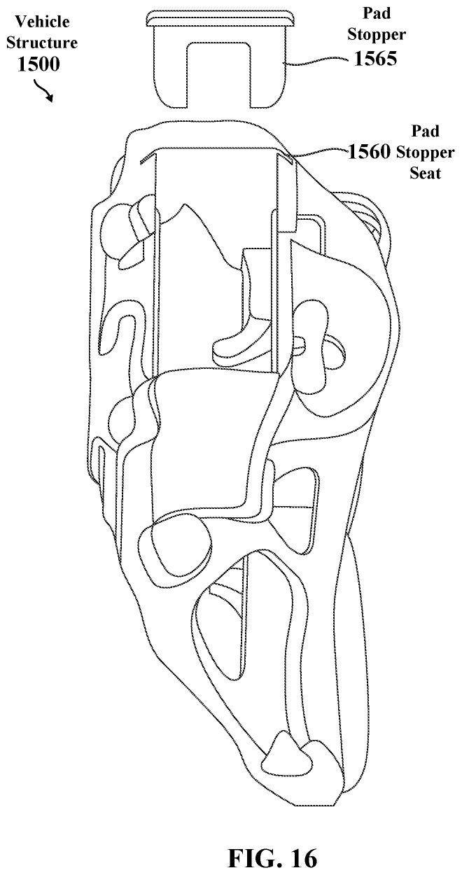

With reference to FIGS. 15-16 the example vehicle structure 1500 includes a pad stopper seat 1560 located in a caliper portion as disclosed herein. The pad stopper seat 1560 may be a slot, channel or other groove formed in the caliper portion. For example, the pad stopper seat 1560 may be formed adjacent to an edge of a bridge or central portion of the caliper portion. The pad stopper seat 1560 is configured to receive a pad stopper 1565, which is shown removed from the vehicle structure 1500.

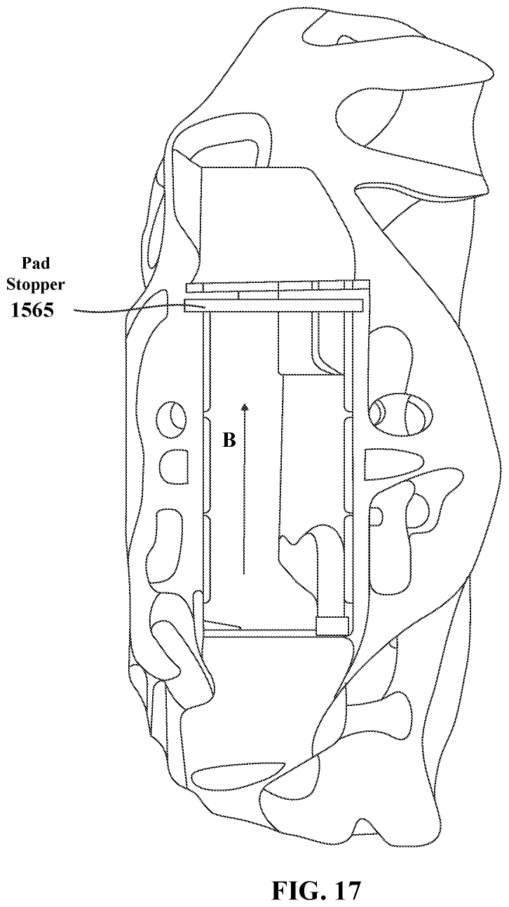

FIGS. 17-20 illustrate the vehicle structure 1500 with the pad stopper 1565 installed or seated in the pad stopper seat 1560. When installed, the pad stopper 1565 is located adjacent to the rotor and the sweep area 1520 along which the rotor is permitted to tilt for installation or removal. The pad stopper 1565 can transmit tangential forces from one or more brake pads to the rest of the vehicle structure 1500, the forces being generated by the braking action of applying the pads to the spinning rotor. The direction of rotation of the rotor 1510 during forward motion of the vehicle is shown by the arrow labeled “B.”

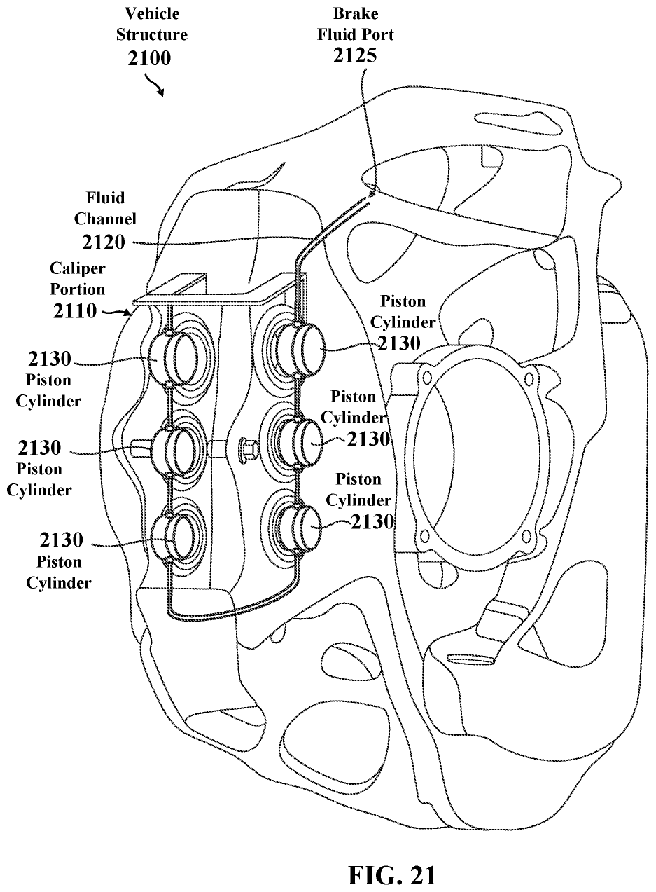

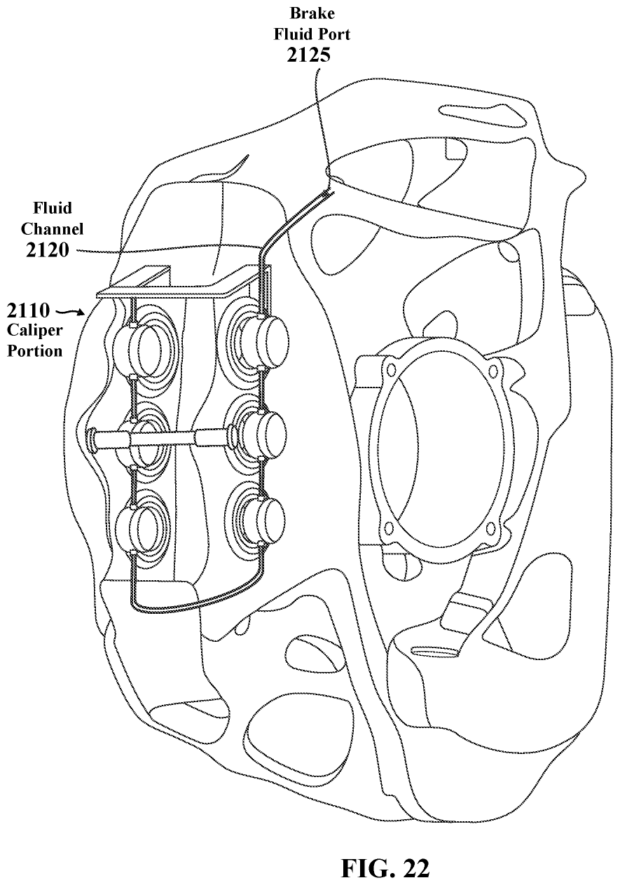

FIGS. 21-22 illustrate an example vehicle structure 2100 showing a printed-in internal fluid channel 2120 according to one or more embodiments. The fluid channel 2120 may provide brake fluid to the piston cylinders 2130 of the caliper portion 2110. In this embodiment, the fluid channel 2120 can be included in the caliper portion and a portion of the stiffening structure. In this way, for example, a brake fluid port 2125 may be positioned closer to a brake fluid source. This may, for example, allow to position the brake fluid port 2125 closer to a steering pivot point, to reduce slack or the exposed length of conventional brake hose, thus reducing the dynamic compliance of the circuit and its exposure to external elements and the total volume of brake fluid contained. In various embodiments, the printed-in fluid channel 2120 may be included in a caliper portion only, in the caliper portion and stiffening structure, in the caliper portion and an upright portion, or any combination thereof.

FIG. 22 illustrates the example vehicle structure highlighting only the printed-in fluid channel, without highlighting the piston cylinders that were highlighted in the previous figure.

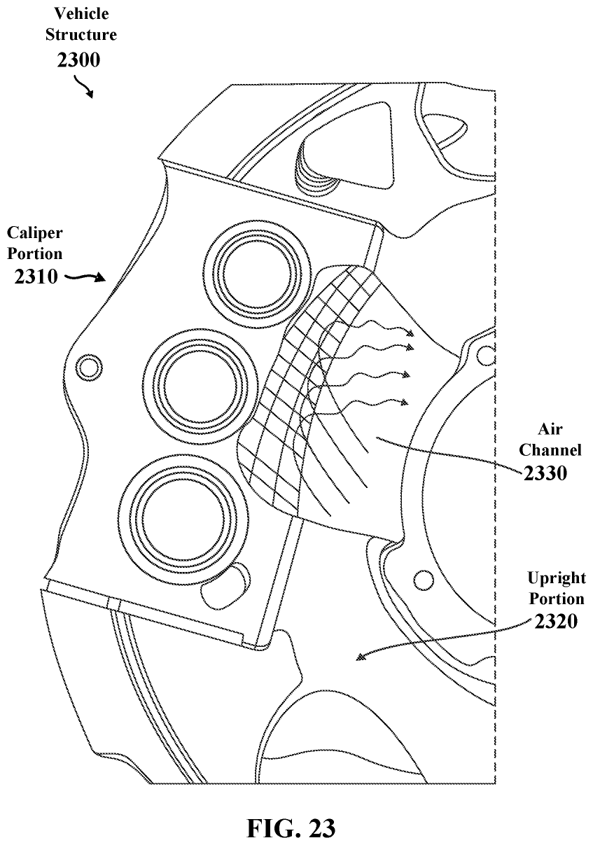

FIGS. 23-25 illustrate an example vehicle structure 2300 showing various cooling elements configured to increase cooling of at least a portion of the vehicle structure.

FIG. 23 illustrates the vehicle structure 2300 having an air channel 2330 that directs airflow from the inner wheel well (i.e., from behind the wheel as viewed from the side of the vehicle). The air channel 2330 may be a printed feature of a caliper portion 2310, in one or more embodiments. In one or more embodiments the air channel 2330 may be a printed feature of an upright portion 2320, The air channel 2330 may be configured as a scoop for air that is directed across the caliper portion 2310 and toward the brake pads.

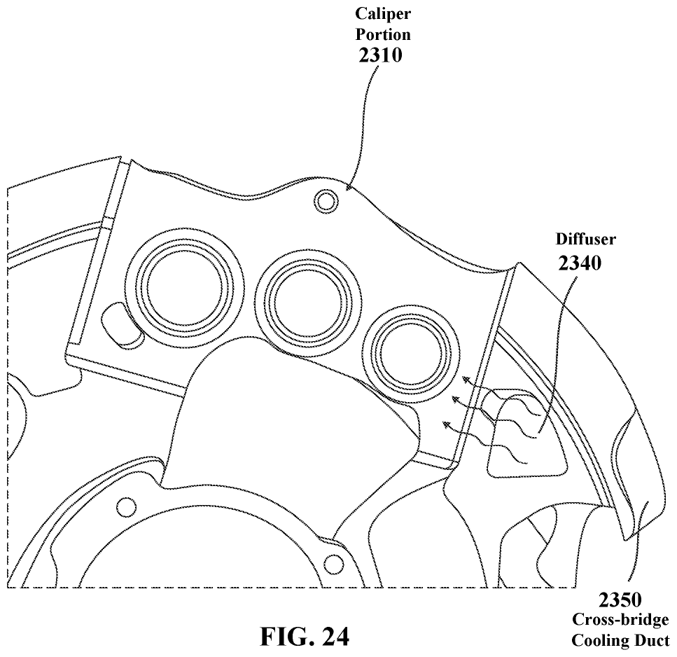

FIG. 24 illustrates the example vehicle structure 2300 showing a diffuser 2340 and a cross-bridge cooling duct 2350 arranged at a side of the caliper portion 2310. The diffuser 2340 and/or the cross-bridge cooling duct 2350 may allow air to flow across the surface of a rotor or the brake pads (not shown). These features may be printed-in to the caliper portion 2310.

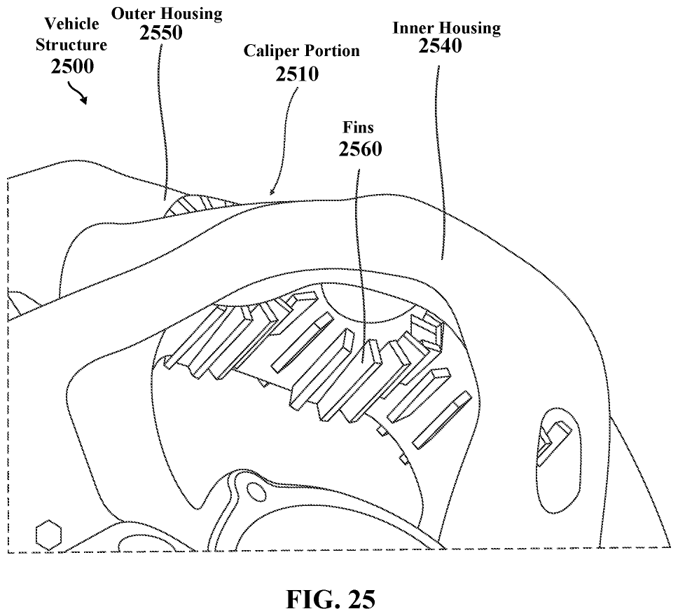

FIG. 25 illustrates an example vehicle structure 2500 showing printed-in fins 2560 for heat dissipation. The fins 2560 may allow better cooling of portions of the vehicle structure 2500. For example, the fins 2560 may be printed-in on the inner and outer housings 2540, 2550 of the caliper portion to allow cooling of the caliper portion 2510 and brake fluid inside the caliper portion.

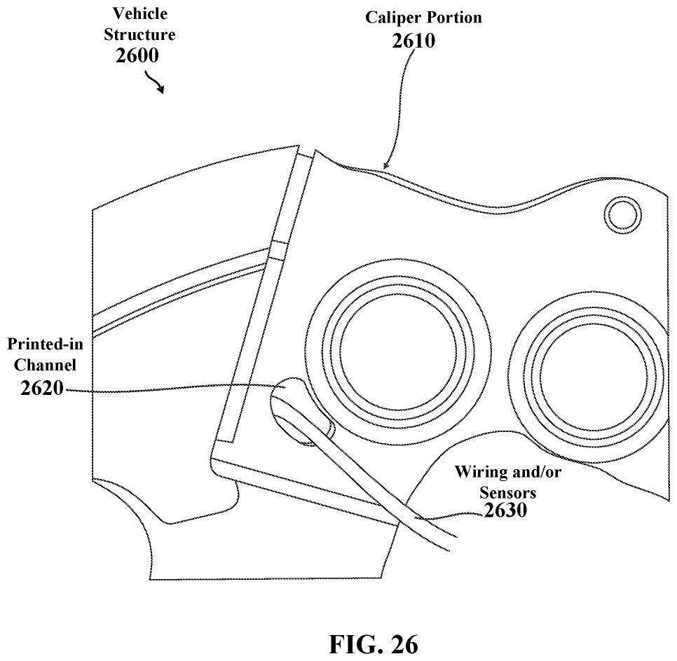

FIG. 26 illustrates an example vehicle structure 2600 showing a caliper portion 2610 having a printed-in channel 2620 for wiring and/or sensors 2630. For example, the printed-in channel 2620 may be configured to seat a pad wear warning sensor, a temperature sensor, or a smart brake pad sensor. Printed-in channels may be used for wiring for sensors or other applications.

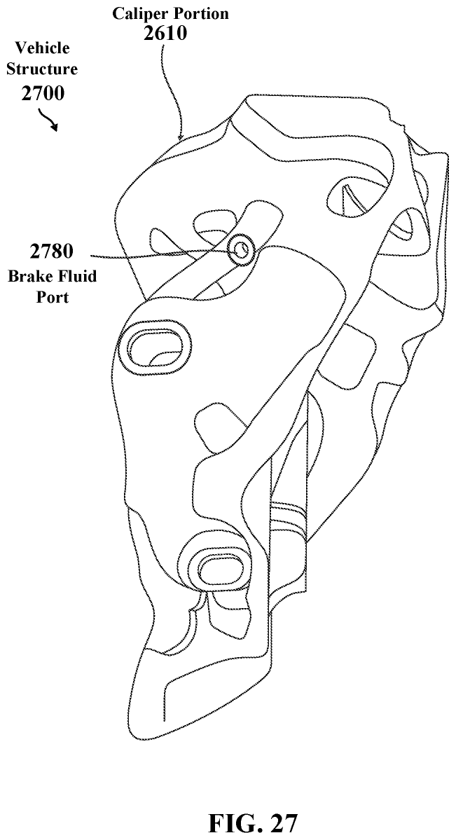

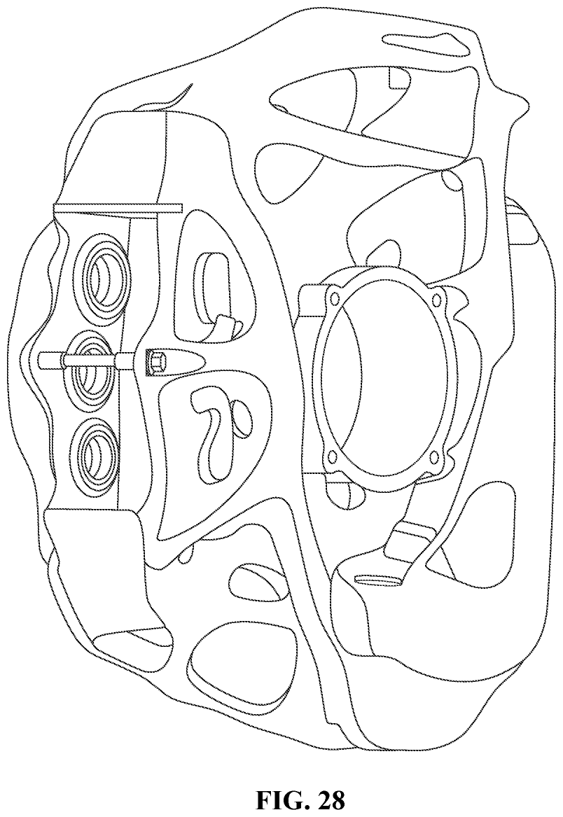

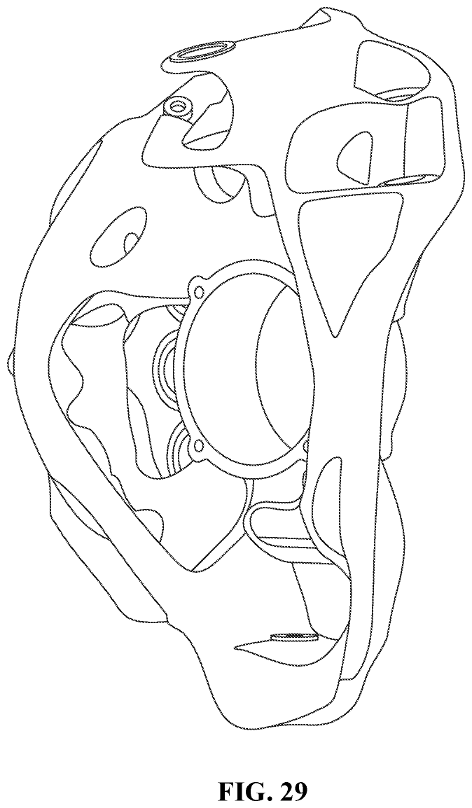

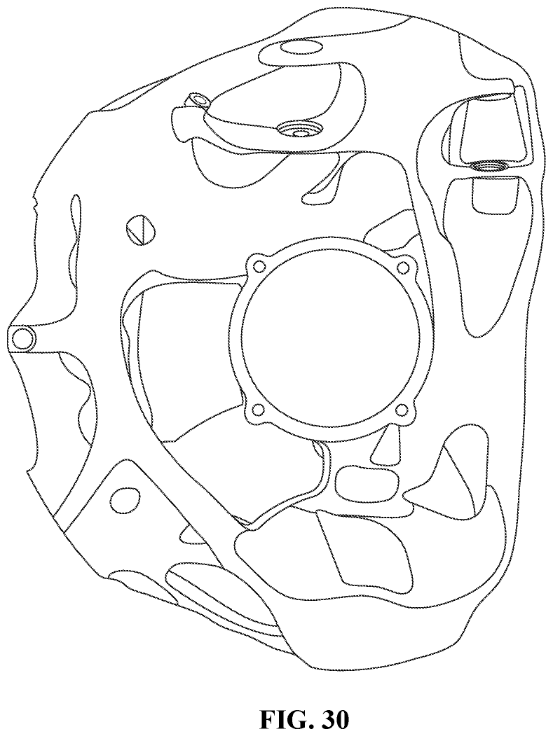

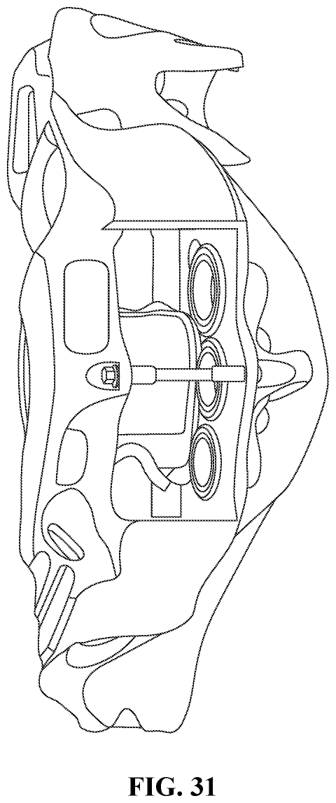

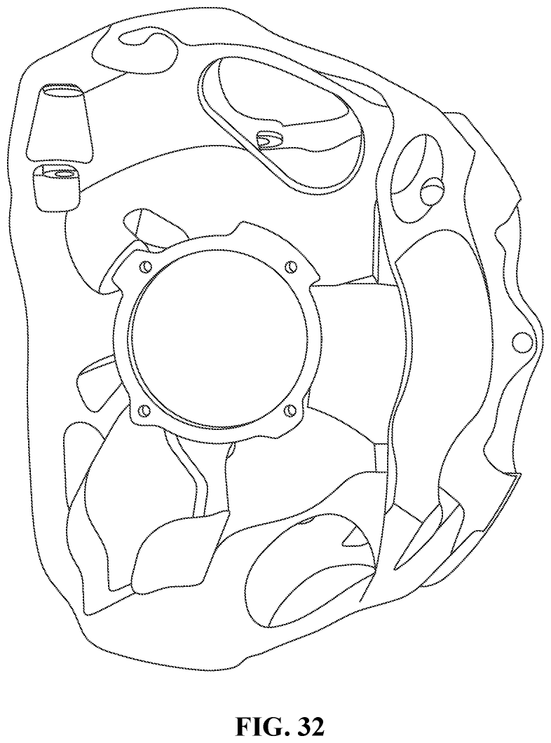

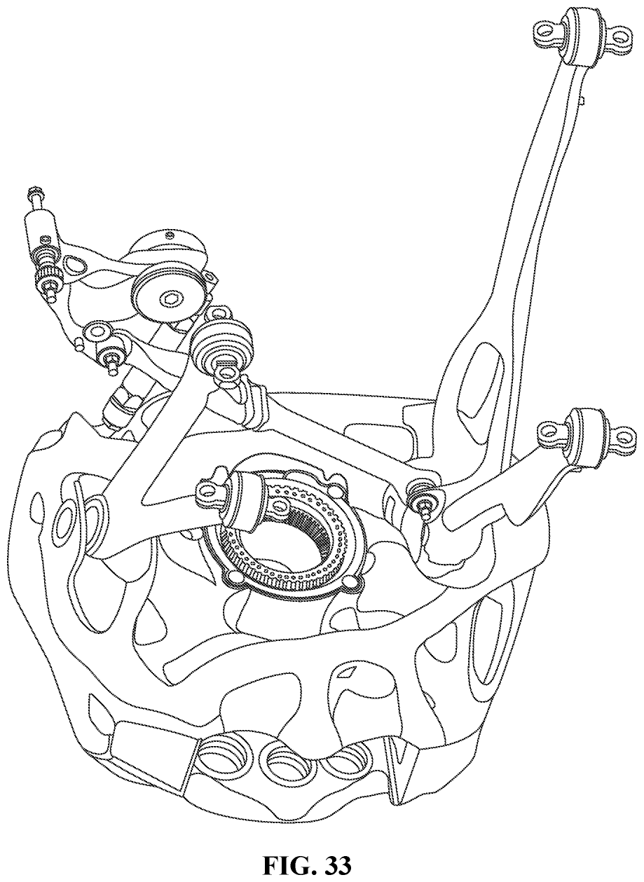

FIGS. 27-33 illustrate example vehicle structures from various different viewpoints and cross-sections. For example, FIG. 27 illustrates a bottom perspective view of a vehicle structure 2700 having a brake fluid port 2780 located on a stiffening portion of a caliper portion 2710.

The detailed description set forth above in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A vehicle structure comprising:
a caliper portion configured to apply a braking force, the caliper portion including an inner housing, an outer housing, and a bridge portion, wherein the bridge portion connects the inner housing and the outer housing;
an upright portion configured to couple to a wheel of a vehicle, the upright portion being connected to the inner housing; and
a stiffening portion that connects the upright portion to at least the bridge portion or the outer housing.

2. The vehicle structure of claim 1, wherein the caliper portion, the upright portion, and the stiffening portion are an integral structure.

3. The vehicle structure of claim 1, wherein the caliper portion, the upright portion, and the stiffening portion are 3D-printed structures.

4. The vehicle structure of claim 1, wherein the stiffening portion includes an outer stiffening structure configured to connect the upright portion to the outer housing.

5. The vehicle structure of claim 4, wherein the stiffening portion further includes a cross stiffening structure that connects the upright portion to the outer stiffening structure.

6. The vehicle structure of claim 1, wherein the stiffening portion includes a bridge stiffening structure configured to connect the upright portion to the bridge portion.

7. The vehicle structure of claim 6, wherein the stiffening portion further includes a cross stiffening structure that connects the upright portion to the bridge stiffening structure.

8. The vehicle structure of claim 1, wherein the stiffening portion includes a cross stiffening structure configured to connect an outer stiffening structure to a bridge stiffening structure.

9. The vehicle structure of claim 1, wherein the stiffening portion is configured to reduce noise, vibration, and harshness (NVH).

10. The vehicle structure of claim 1, wherein at least the caliper portion, the upright portion, or the stiffening portion is at least partially hollow.

11. The vehicle structure of claim 1, wherein the caliper portion is a 3D-printed structure, and the caliper portion includes a printed-in fluid channel configured to provide brake fluid to the inner and outer housings.

12. The vehicle structure of claim 11, wherein at least the upright portion or the stiffening portion is a 3D-printed structure and includes a portion of the printed-in fluid channel.

13. The vehicle structure of claim 1, further comprising a cooling element configured to increase cooling of at least a portion of the vehicle structure.

14. The vehicle structure of claim 13, wherein the cooling element includes at least 3D-printed fins, a channel for airflow, a channel for airflow from a wheel well, an air scoop, a diffuser, or a cross-bridge cooling duct.

15. The vehicle structure of claim 1, wherein at least the caliper portion, the upright portion, or the stiffening portion includes a printed-in channel for installing at least a wiring or a sensor.

16. The vehicle structure of claim 15, wherein the printed-in channel is configured for at least a pad wear warning sensor, a temperature sensor, or a smart brake pad sensor.

17. A vehicle structure comprising:
a caliper portion configured to apply a braking force, the caliper portion including an inner housing, an outer housing, and a bridge portion, wherein the bridge portion connects the inner housing and the outer housing, the outer housing including an inner surface configured to face a rotor, wherein the inner surface includes a sweep area configured to allow the rotor to tilt during installation and removal of the rotor; and
an upright portion configured to couple to a wheel of a vehicle, the upright portion being connected to the inner housing.

18. The vehicle structure of claim 17, wherein the sweep area includes a curved surface.

19. The vehicle structure of claim 17, further comprising:
a seat configured to seat a pad stopper, the pad stopper being configured to transfer a force from a portion of a brake pad to the vehicle structure, wherein the portion of the brake pad is an area of the brake pad that, because of the sweep area, would not be in contact with the vehicle structure during braking.

20. The vehicle structure of claim 19, wherein the seat is configured to seat a plate-like pad stopper.

21. The vehicle structure of claim 19, wherein the seat includes a slot.

22. The vehicle structure of claim 19, further comprising the pad stopper installed in the seat.

23. The vehicle structure of claim 19, wherein the seat is configured to seat a pad stopper that includes stopper portions for both an inner brake pad and an outer brake pad.

24. The vehicle structure of claim 19, wherein the seat is configured to seat a pad stopper that includes a stopper portion for only an outer brake pad.

25. The vehicle structure of claim 19, wherein the seat is arranged at a forward side of the caliper portion.

26. The vehicle structure of claim 25, further comprising:
a second seat configured to seat a second pad stopper, wherein the second seat is arranged at a rear side of the caliper portion.

27. The vehicle structure of claim 17, wherein the caliper portion is a 3D-printed structure, and the caliper portion includes a printed-in fluid channel configured to provide brake fluid to the inner and outer housings.

28. The vehicle structure of claim 27, wherein at least the upright portion or a stiffening portion that connects the upright portion to at least the bridge portion or the outer housing is a 3D-printed structure and includes a portion of the printed-in fluid channel.

29. The vehicle structure of claim 17, further comprising:
a cooling element configured to increase cooling of at least a portion of the vehicle structure.

30. The vehicle structure of claim 29, wherein the cooling element includes at least 3D-printed fins, a channel for airflow, a channel for airflow from a wheel well, an air scoop, a diffuser, or a cross-bridge cooling duct.

31. The vehicle structure of claim 17, wherein at least the caliper portion, the upright portion, or a stiffening portion that connects the upright portion to at least the bridge portion or the outer housing includes a printed-in channel for installing at least a wiring or a sensor.

32. The vehicle structure of claim 31, wherein the printed-in channel is configured for at least a pad wear warning sensor, a temperature sensor, or a smart brake pad sensor.
